(19) United States
(12) Patent Application Publication
(10) Pub. No.: US 2026/0320402 A1
(43) Pub. Date: Oct. 15, 2026

(54) DATA-EFFICIENT REINFORCEMENT LEARNING WITH ADAPTIVE RETURN COMPUTATION SCHEMES

(71) Applicant: DeepMind Technologies Limited, London (GB)

(72) Inventors: Ray Jiang, London (GB); Adrià Puigdomènech Badia, London (GB); Víctor Campos Camúñez, London (GB); Steven James Kapturowski, St. Albans (GB); Nemanja Rakicevic, London (GB)

(21) Appl. No.: 19/112,006

(22) PCT Filed: Sep. 15, 2023
(86) PCT No.: PCT/EP2023/075512

§ 371 Date: Mar. 14, 2025

Related U.S. Application Data
(60) Provisional application No. 63/407,132, filed on Sep. 15, 2022.

(51) Int. Cl. G06N 3/092; G06N 3/045

(52) U.S. Cl. CPC G06N 3/092; G06N 3/045

(57) ABSTRACT

Methods, systems, and apparatus, including computer programs encoded on a computer storage medium, for data-efficient reinforcement learning with adaptive return computation schemes.

### CROSS-REFERENCE TO RELATED APPLICATIONS

This application claims the benefit of priority to U.S. Provisional Application Ser. No. 63/407,132, filed Sep. 15, 2022, the entirety of which is incorporated herein by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to perform a task in the environment using an action selection neural network system that includes one or more action selection neural networks and, optionally, one or more distilled policy neural networks. This specification also describes training the action selection neural network system.

Particular embodiments of the subject matter described in this specification can be implemented so as to realize one or more of the following advantages.

In some of the implementations described in the specification, the system described in this specification maintains a policy that the system uses to select the most appropriate return computation scheme to use for any given task episode that is performed during training of a set of one or more action selection neural network(s) that are used to control an agent interacting with an environment in order to perform a task. Each possible return computation scheme assigns a different importance to exploring the environment while the agent interacts with the environment. In particular, each possible return compensation scheme specifies a discount factor to be used in computing returns, an intrinsic reward scaling factor used in computing overall rewards, or both. More specifically, the system uses an adaptive mechanism to adjust the policy throughout the training process, resulting in different return computation schemes being more likely to be selected at different points during the training. Using this adaptive mechanism allows the system to effectively select the most appropriate time horizon for computing returns, the most appropriate degree of exploration, or both at any given time during training. This results in trained neural networks that can exhibit improved performance when controlling an agent to perform any of a variety of tasks.

However, some existing systems that use such adaptive mechanisms in order to allow the same set of one or more neural networks to be effectively trained to solve a variety of different tasks require a large amount of training data for any given task in order to be able to effectively control the agent to perform the task. Thus, these systems are not usable for tasks where training data is limited, where acquiring training data is computationally expensive or where acquiring training data requires controlling a real-world agent and can cause damage or wear and tear to the agent or to the environment.

This techniques described in this specification address these issues by modifying the training of the neural network(s) to be more data-efficient, i.e., to require significantly smaller amounts of data in order to achieve similar or better performance, on even complex, real-world tasks as compared to existing systems, e.g., existing systems that use adaptive mechanisms or other similar systems. For example, for some tasks, the system can require as much as 200-fold less experience (training data) to out-perform a human-controlled policy as compared to existing systems that use the above adaptive mechanisms.

Thus, compared to conventional systems, the system described in this specification may consume fewer computational resources (e.g., memory and computing power) by training the action selection neural network(s) to achieve an acceptable level of performance over fewer training iterations. Moreover, a set of one or more action selection neural networks trained by the system described in this specification can select actions that enable the agent to accomplish tasks more effectively (e.g., more quickly) than an action selection neural network trained by an alternative system.

More generally, as one example, this specification describes techniques for more effectively making use of a target network during the training an action selection neural network in order to make the training of the action selection neural network more data-efficient while maintaining the stability of the training process.

As another example, this specification describes techniques for determining a target return estimate during the training of an action selection neural network to more effectively incorporate off-policy data into the training process in order to make the training of the action selection neural network more data-efficient while maintaining the quality of the updates computed as part of the training process.

As yet another example, this specification describes techniques for incorporating a distilled action selection neural network, e.g., a distilled policy neural network, for use in generating training data during training. Incorporating the distilled action selection neural network can increase the quality of the generated training data, resulting in a more data-efficient training process that decreases the number of transitions required for performance to reach an acceptable level.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2A shows an example training system.

FIG. 2B shows an example architecture of the action selection neural network system.

FIG. 3 shows an example intrinsic reward system.

FIG. 4 is a flow diagram of an example process for controlling an agent to perform a task episode and for updating the return computation scheme selection policy.

FIG. 5A is a flow diagram of an example process for training the action selection neural network system.

FIG. 5B shows an example of which action scores would result in a transition being included in a reinforcement learning loss.

FIG. 6 is a flow diagram of an example process for training a distilled action selection neural network that corresponds to a given return computation scheme.

FIG. 7 shows an example of the performance of the described techniques relative to a conventional approach across a variety of tasks.

Like reference numbers and designations in the various drawings indicate like elements.

### DETAILED DESCRIPTION

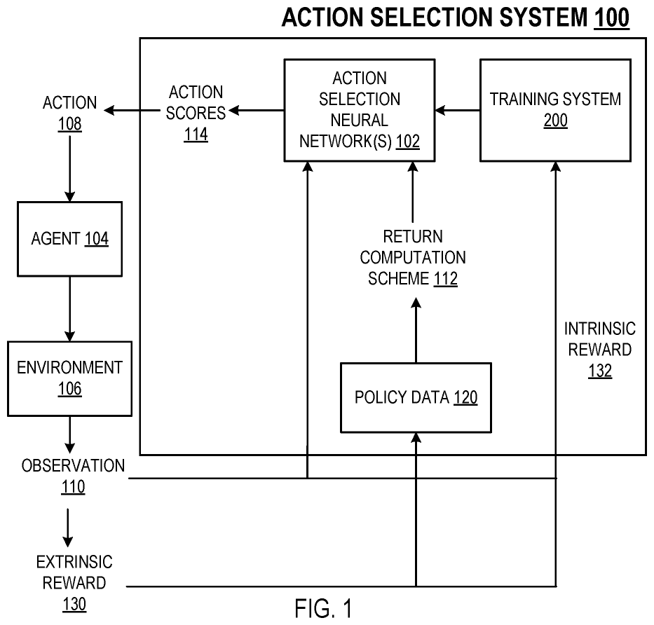

FIG. 1 shows an example action selection system 100. The action selection system 100 is an example of a system implemented as computer programs on one or more computers in one or more locations in which the systems, components, and techniques described below are implemented.

The action selection system 100 uses one or more action selection neural network(s) 102 and policy data 120 to control an agent 104 interacting with an environment 106 to accomplish a task by selecting actions 108 to be performed by the agent 104 at each of multiple time steps during the performance of an episode of the task.

An “episode” of a task is a sequence of interactions during which the agent attempts to perform an instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent performs the action 108, the environment 106 transitions into a new state and the system 100 receives an extrinsic reward 130 from the environment 106.

Generally, the extrinsic reward 130 is a scalar numerical value and characterizes a progress of the agent 104 towards completing the task.

As a particular example, the extrinsic reward 130 can be a sparse binary reward that is zero unless the task is successfully completed and one if the task is successfully completed as a result of the action performed.

As another particular example, the extrinsic reward 130 can be a dense reward that measures a progress of the agent towards completing the task as determined based on individual observations received during the episode of attempting to perform the task, i.e., so that non-zero rewards can be and frequently are received before the task is successfully completed.

While performing any given task episode, the system 100 selects actions in order to attempt to maximize a return that is received over the course of the task episode.

That is, each at time step during the episode, the system 100 selects actions that attempt to maximize the return that will be received for the remainder of the task episode starting from the time step.

Generally, at any given time step, the return that will be received is a combination of the rewards that will be received at time steps that are after the given time step in the episode.

For example, at a time step t, the return can satisfy:

$${\sum }_{i} {γ}^{i - t - 1} {r}_{i} ,$$

where i ranges either over all of the time steps after t in the episode or for some fixed number of time steps after t within the episode, γ is a discount factor, and rᵢ is an overall reward at time step i. As can be seen from the above equation, higher values of the discount factor result in a longer time horizon for the return calculation, i.e., result in rewards from more temporally distant time steps from the time step t being given more weight in the return computation.

In some implementations, the overall reward for a given time step is equal to the extrinsic reward received at the time step, i.e., received as a result of the action performed at the preceding time step.

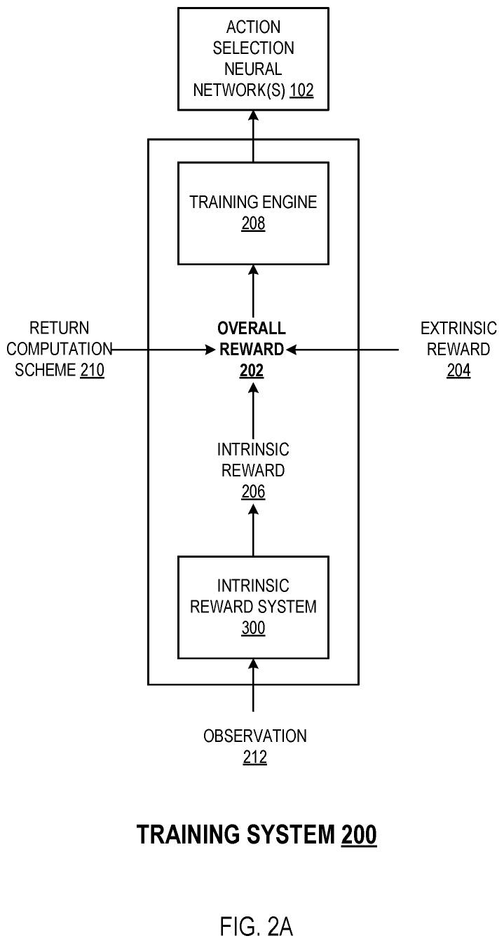

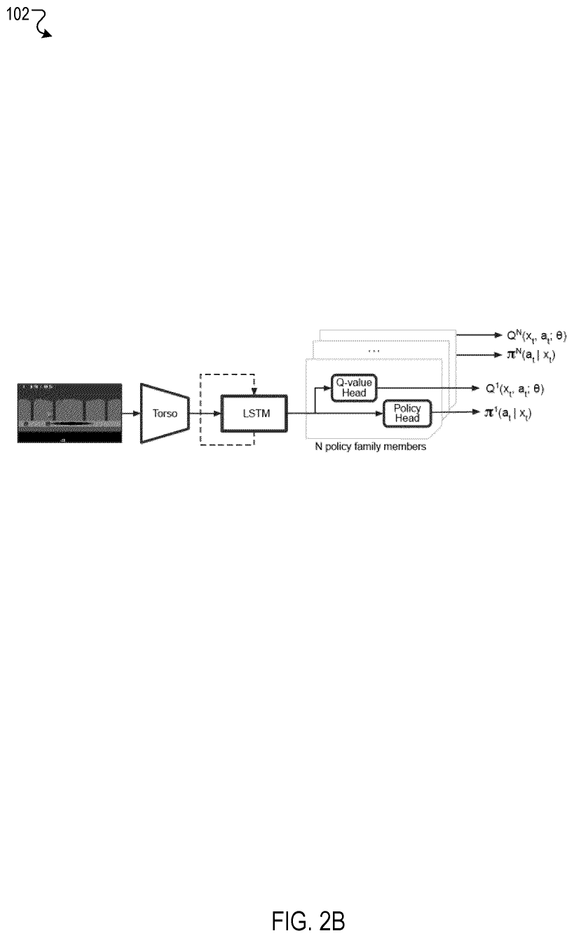

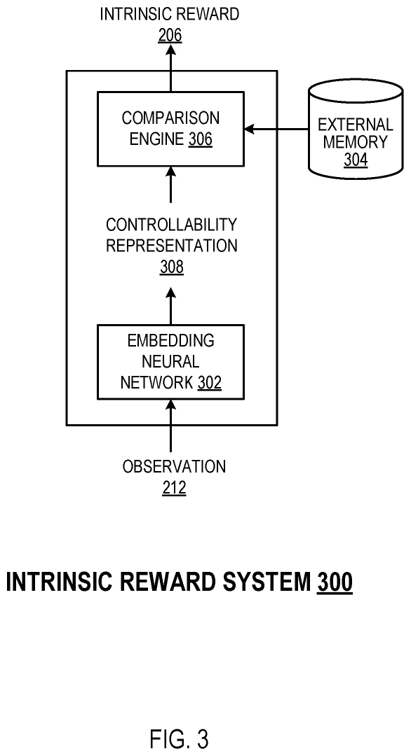

In some other implementations, the system 100 also obtains, i.e., receives or generates, an intrinsic reward 132 from at least the observation received at the time step. The intrinsic reward 132 characterizes a progress of the agent towards exploring the environment as of the time step in a manner that is independent of the task being performed, i.e., instead of, like the extrinsic reward 130, characterizing the progress of the agent towards completing the task as of the time step. The intrinsic reward 132 is typically not derived using extrinsic rewards 130 from the present episode or from any previous episode. That is, the intrinsic reward 132 measures exploration of the environment rather than measuring the performance of the agent on the task. For example, the intrinsic reward may be a value indicative of an extent to which the observations provide information about the whole environment and/or the possible configurations of objects within it; for example, if the environment is a real-world environment and the observations are images (or other sensor data) relating to corresponding parts of the environment, the intrinsic reward may be a value indicative of how much of the environment has appeared in at least one of the images. Computing an intrinsic reward for a time step will be described in more detail below with reference to FIGS. 2A and 3.

In these implementations, the system 100 can determine the “overall” reward received by the agent at a time step based at least on: (i) the extrinsic reward for the time step, (ii) the intrinsic reward for the time step, and (iii) an intrinsic reward scaling factor.

As a particular example, the system 100 can generate the overall reward rₜ for the time step t, e.g., as:

$${r}_{t} = {r}_{t}^{task} + β \cdot {r}_{t}^{exploration}$$

where

$${r}_{t}^{task}$$

denotes the extrinsic reward for the time step,

$${r}_{t}^{exploration}$$

denotes the intrinsic reward for the time step, and β denotes the intrinsic reward scaling factor. It can be appreciated that the value of the intrinsic reward scaling factor controls the relative importance of the extrinsic reward and the intrinsic reward to the overall reward, e.g., such that a higher value of the intrinsic reward scaling factor increases the contribution of the intrinsic reward to the overall reward. Other methods for determining the overall reward from the extrinsic reward, the intrinsic reward, and the intrinsic reward scaling factor in which the value of the intrinsic reward scaling factor controls the relative importance of the extrinsic reward and the intrinsic reward to the overall reward are possible, and the above equation is provided for illustrative purposes only.

The policy data 120 is data specifying a policy (a “return computation scheme selection policy”) for selecting between multiple different return computation schemes from a set of return computation schemes.

Each return computation scheme in the set assigns a different importance to exploring the environment while performing the episode of the task. In other words, some return computation schemes in the set assign more importance to exploring the environment, i.e., collecting new information about the environment, while other return computation schemes in the set assign more importance to exploiting the environment, i.e., exploiting current knowledge about the environment.

As one particular example, each return computation scheme can specify at least a respective discount factor γ that is used in combining rewards to generate returns. In other words, some return computation schemes can specify relatively larger discount factors, i.e., discount factors that result in rewards at future time steps being weighted relatively more heavily in the return computation for a current time step, than other return computation schemes.

As another particular example, each return computation scheme can specify at least a respective intrinsic reward scaling factor β that defines an importance of the intrinsic reward relative to the extrinsic reward that is received from the environment when generating returns.

In particular, as described above, the intrinsic reward scaling factor defines how much the intrinsic reward for a given time step is scaled before being added to the extrinsic reward for the given time step to generate an overall reward for the time step. In other words, some return computation schemes can specify relative larger intrinsic reward scaling factors, i.e., scaling factors that result in the intrinsic reward at the time step being assigned a relatively larger weight in the calculation of the overall return at the time step, than other return computation schemes.

As another particular example, each return computation scheme can specify a respective discount factor—intrinsic reward scaling factor pair, i.e. a γ-β pair, so that each scheme in the set specifies a different combination of values for the discount factor and the scaling factor from each other set in the scheme.

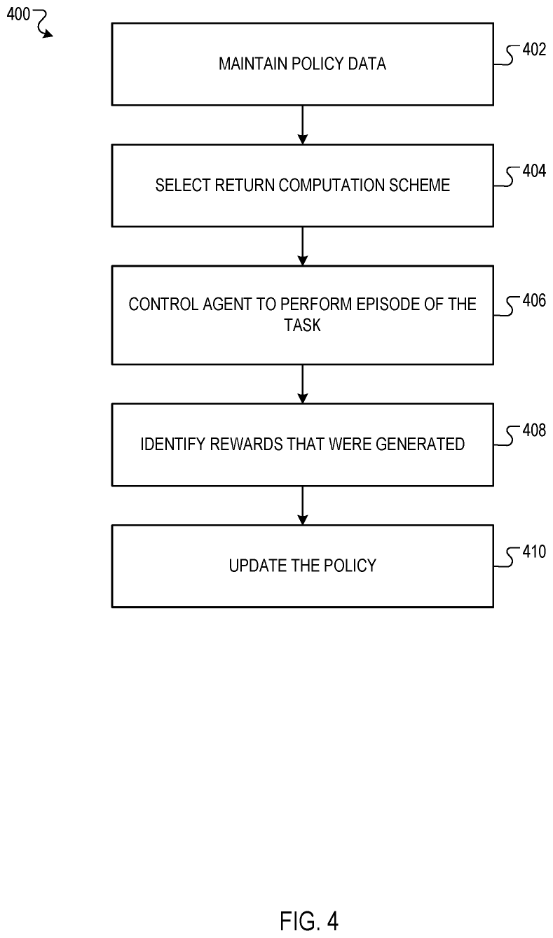

Before performing the episode, the system 100 selects a return computation scheme from the multiple different schemes in the set using the return computation scheme selection policy currently specified by the policy data 120. For example, the system 100 can select a scheme based on reward scores assigned to the schemes by the return computation scheme selection policy. Selecting a scheme is described in more detail below with reference to FIG. 4. As will be described in more detail below, the return computation scheme selection policy is adaptively modified during training so that different schemes become more likely to be selected at different times during the training.

The system 100 then controls the agent 104 to perform the task episode in accordance with the selected scheme, i.e., to maximize returns computed using the selected scheme, using the one or more action selection neural network(s) 102.

To do so, at each time step in the episode, the system 100 controls the agent using (i) outputs generated by the action selection neural network corresponding to the selected return computation scheme or (ii) using a distilled policy neural network corresponding to the selected return computation scheme and that is trained using the action selection neural network corresponding to the selected return computation scheme. In other words, in some implementations, during training, the system 100 directly uses the action selection neural network corresponding to the selected return computation scheme to control the agent 104. In some other implementations, the system uses a distilled policy neural network corresponding to the selected return computation scheme to control the agent 104 and only uses the action selection neural network to train the distilled policy neural network.

The policy neural network is referred to as “distilled” because the policy neural network is trained by “distilling” from outputs of the corresponding action selection neural network during training.

The policy neural network for a given return computation scheme is a neural network that processes an input that includes an observation to generate an output that defines a probability distribution over the set of action scores, with the probability for each action representing the likelihood that performing the action in response to the observation will maximize the return received for the remainder of the episode (given that the return is computed using the given return computation scheme). For example, the output can include a respective probability for each action in the set when the set of actions are discrete or can include the parameters of a probability distribution over the set of actions when the set of actions are continuous.

When the action selection neural network 102 is used to control the agent, the system 100 processes, using the action selection neural network(s) 102, an input including an observation 110 characterizing the current state of the environment at the time step to generate action scores 114.

The action scores 114 (also referred to as “return estimates” or “Q values”) can include a respective numerical value for each action in a set of possible actions and are used by the system 100 to select the action 108 to be performed by the agent 104 at the time step.

The action selection neural network(s) 102 can be understood as implementing a family of action selection policies that are indexed by the possible return computation schemes in the set.

In particular, a training system 200 (which will be described in more detail with reference to FIG. 2A) can train the action selection neural network(s) 102 such that the selected return computation scheme characterizes the degree to which the corresponding action selection policy is “exploratory”, i.e., selects actions that cause the agent to explore the environment. In other words, the training system 200 trains the action selection neural network(s) 102 such that conditioning the neural network(s) on the selected scheme causes the network(s) to generate outputs that define action selection policies that place more or less emphasis on exploring versus exploiting the environment depending on which scheme was selected.

When there are multiple return computation schemes, there are generally multiple action selection neural networks, with each corresponding to a different one of the return computation schemes. In some of these implementations, some portions of the action selection neural networks are shared across all of the action selection neural networks. For example, the neural networks can have a “shared” torso, i.e., so that each action selection neural network is implemented as one or more respective “heads” on top of the shared torso. This is described in more detail below with reference to FIG. 2B.

In some implementations, each action selection neural network 102 generates two separate outputs: (i) intrinsic reward action scores that estimates intrinsic returns computed only from intrinsic rewards generated by an intrinsic reward system based on observations received during interactions with the environment; and (ii) extrinsic reward action scores that estimates extrinsic returns computed only from extrinsic rewards received from the environment as a result of interactions with the environment.

In some of these implementations, the two separate outputs are generated by two separate heads on the same shared torso.

In these implementations, the system 100 processes the input using action selection neural network 102 to generate a respective intrinsic action score (“estimated intrinsic return”) for each action and a respective extrinsic action score (“estimated extrinsic return”) for each action.

The system 100 can then combine the intrinsic action score and the extrinsic action score for each action in accordance with the intrinsic reward scaling factor to generate the final action score (“final return estimate”) for the action.

As one example, the final action score Q(x, a, j; θ) for an action a in response to an observation x given that the j-th scheme was selected can satisfy:

$$Q ( x , a , j ; θ ) = Q ( x , a , j ; {θ}^{e} ) + {β}_{j} \cdot Q ( x , a , j ; {θ}^{i} ) ,$$

where Q(x, a, j; θ^{e}) is the extrinsic action score for action a, Q(x, a, j; θⁱ) is the intrinsic action score for action a, and βⱼ is the scaling factor in the j-th scheme. In this example, θ are the parameters of the corresponding action selection neural networks, which include the parameters θ^{e} used to generate the extrinsic action score and the parameters θⁱ used to generate the intrinsic action score. For example, when, as described below, the action selection neural networks have some shared parameters and then respective heads for generating the extrinsic and intrinsic action scores, θ includes the shared parameters and the parameters of the two heads of the corresponding action selection neural networks, θ^{e} includes the shared parameters and the parameters of the extrinsic head, and θ includes the shared parameters and the parameters of the intrinsic head.

As another example, the final action score Q(x, a, j; θ) can satisfy:

$$Q ( x , a , j ; θ ) = h ( {h}^{- 1} ( Q ( x , a , j ; {θ}^{e} ) ) + {β}_{j} {h}^{- 1} ( Q ( x , a , j ; {θ}^{i} ) ) ) ,$$

where h is a monotonically increasing and invertible squashing function that scales the state-action value function, i.e., the extrinsic and intrinsic reward functions, to make it easier to approximate for a neural network.

Thus, different values of βⱼ in the return scheme cause the predictions of the intrinsic action selection neural network to be weighted differently when computing the final action score.

In some implementations, the system 100 can use the action scores 114 to select the action 108 to be performed by the agent 104 at the time step.

For example, the system 100 may process the action scores 114 to generate a probability distribution over the set of possible actions, and then select the action 108 to be performed by the agent 104 by sampling an action in accordance with the probability distribution. The system 100 can generate the probability distribution over the set of possible actions, e.g., by processing the action scores 114 using a soft-max function. As another example, the system 100 may select the action 108 to be performed by the agent 104 as the possible action that is associated with the highest action score 114. Optionally, the system 100 may select the action 108 to be performed by the agent 104 at the time step using an exploration policy, e.g., an ∈-greedy exploration policy in which the system 100 selects the action with the highest final return estimate with probability 1−ε and selecting a random action from the set of actions with probability ε.

As described above, in some other implementations, the system uses the action scores 114 to train the distilled policy neural network and uses the distilled policy neural network to control the agent during training.

Once the task episode has been performed, i.e., once the agent successfully performs the task or once some termination criterion for the task episode has been satisfied, the system 100 can use the results of the task episode to (i) update the return computation scheme selection policy that is currently specified by the policy data 120, (ii) train the action selection neural network(s) 102, or both.

More generally, both the policy specified by the policy data 120 and the parameter values of the action selection neural network(s) 102 are updated during training based on trajectories generated as a result of interactions of the agent 104 with the environment.

In particular, during training, the system 100 updates the return computation scheme selection policy using recently generated trajectories, e.g., considering the trajectories as being arranged in the order in which they were generated, trajectories generated within a sliding window of a fixed size and ending with the most recently generated trajectory. By using this adaptive mechanism to adjust the return computation scheme selection policy throughout the training process, different return computation schemes are more likely to be selected at different points during the training of the action selection neural network(s). Using this adaptive mechanism allows the system 100 to effectively select the most appropriate time horizon, the most appropriate degree of exploration, or both at any given time during the training. This results in trained neural network(s) that can exhibit improved performance when controlling the agent to perform any of a variety of tasks.

Updating the return computation scheme selection policy is described in more detail below with reference to FIG. 4

The system 100 trains the action selection neural network(s) 102 using trajectories that are generated by the system 100 and added to a data store referred to as a replay buffer. In other words, at specified intervals during training, the system 100 samples trajectories from the replay buffer and uses the trajectories to train the neural network(s) 102. In some implementations, the trajectories used to update the return computation scheme selection policy are also added to the replay buffer for later use in training the neural network(s) 102. In other implementations, trajectories used to update the return computation scheme selection policy are not added to the replay buffer and are only used for updating the return computation scheme selection policy. For example, the system 100 may alternate between performing task episodes that will be used to update the return computation scheme selection policy and performing task episodes that will be added to the replay buffer.

Generally, the system 100 performs the training process in a manner that results in the training process being more data-efficient relative to existing techniques.

As one example, the training of the action selection neural networks can be improved to be more data-efficient relative to existing techniques.

As one example of this, as is described below, the system can more efficiently make use of target neural networks during the training.

A target neural network corresponding to a given neural network is a neural network that has the same architecture as the given neural network but that has target values of the network parameters that are constrained to change more slowly than the current values of the network parameters of the given neural network during the training. For example, the target values can be updated to be equal to the current values only after every N training iterations, where an iteration corresponds to training the given neural network on a batch of one or more transition sequences and where Nis an integer that is greater than 1, and not updating the target values at any other training iterations. As another example, the target values can be maintained as a moving average of the current values during the training, ensuring that the target values change more slowly.

As another example, and as briefly described above, a distilled policy neural network can be used to control the agent in the environment during training to improve the data-efficiency of the training process. In particular, the system can use the distilled policy neural network to generate higher quality transitions for the training, resulting in improved performance after fewer transitions have been used in training.

While the above description and the description that follows describes that there are multiple return computation schemes, the training techniques described below and the techniques for controlling the agent using a distilled policy neural network can also be used to improve the data efficiency of reinforcement learning when there is only a single return computation scheme and, therefore, the action selection neural network system includes only a single action selection neural network (and, optionally, a corresponding policy neural network).

Moreover, the training techniques described below can also be used to improve data efficiency when there are only extrinsic rewards, and not intrinsic rewards, being used for the training.

Training the action selection neural network(s) is described below with reference to FIG. 2A.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use of a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment such as a heater, a cooler, a humidifier, or other hardware that modifies a property of air in the real-world environment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that indirectly performs or controls the protein folding actions, e.g., by controlling chemical synthesis steps selected by the system automatically without human interaction. The observations may comprise direct or indirect observations of a state of the protein or chemical/intermediates/precursors and/or may be derived from simulation. Thus, the system may be used to automatically synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound and the agent is a computer system for determining elements of the pharmaceutically active compound and/or a synthetic pathway for the pharmaceutically active compound. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2A shows an example training system 200. The training system 200 is an example of a system implemented as computer programs on one or more computers in one or more locations in which the systems, components, and techniques described below are implemented.

The training system 200 is configured to train the action selection neural network(s) 102 (as described with reference to FIG. 1) to optimize a cumulative measure of overall rewards received by an agent by performing actions that are selected using the action selection neural network(s) 102.

As described above, the training system 200 can determine the “overall” reward 202 received by the agent at a time step based at least on: (i) an “extrinsic” reward 204 for the time step, (ii) an “exploration” reward 206 (“intrinsic reward”) for the time step, and (iii) an intrinsic reward scaling factor specified by the return computation scheme 210 that was sampled for the episode to which the time step belongs.

As described above, the intrinsic reward 206 may characterize a progress of the agent towards exploring the environment at the time step. For example, the training system 200 can determine the intrinsic reward 206 for the time step based on a similarity measure between: (i) an embedding of an observation 212 characterizing the state of the environment at the time step, and (ii) embeddings of one or more previous observations characterizing states of the environment at respective previous time steps. In particular, a lower similarity between the embedding of the observation at the time step and the embeddings of observations at previous time steps may indicate that the agent is exploring a previously unseen aspect of the environment and therefore result in a higher intrinsic reward 206. The training system 200 can generate the intrinsic reward 206 for the time step by processing the observation 212 characterizing the state of the environment at the time step using an intrinsic reward system 300, which will be described in more detail with reference to FIG. 3.

To train the action selection neural network(s) 102, the training system 200 obtains a “trajectory” characterizing interaction of the agent with the environment over one or more (successive) time steps during a task episode. The data for a given time step in a trajectory will be referred to as a “transition.” In particular, the trajectory may specify for each time step: (i) the observation 212 characterizing the state of the environment at the time step, (ii) the intrinsic reward 206 for the time step, and (iii) the extrinsic reward 204 for the time step. The trajectory also specifies the return computation scheme corresponding to the trajectory, i.e., that was used to select the actions performed by the agent during the task episode.

Generally, a training engine 208 can thereafter train the action selection neural network(s) 102 by computing respective overall rewards for each time step from the intrinsic reward for the time step, the extrinsic reward for the time step, and an intrinsic reward scaling factor as described above, i.e., either a constant intrinsic reward scaling factor or, if different return computation schemes specify different intrinsic reward scaling factors, the intrinsic reward scaling factor specified by the return computation scheme corresponding to the trajectory.

The training engine 208 can then train the action selection neural network on the trajectory using a reinforcement learning technique. The reinforcement learning technique can be, e.g., a Q-learning technique, e.g., a Retrace Q-learning technique or a Retrace Q-learning technique with a transformed Bellman operator, such that the action selection neural network is a Q neural network and the action scores are Q values that estimate expected returns that would be received if the corresponding actions were performed by the agent.

Generally, the reinforcement learning technique uses discount factors for rewards received at future time steps in the trajectory, estimates of future returns to be received after any given time step, or both to compute target outputs for the training of the action selection neural network. When training on the trajectory, the system 200 uses the discount factor in the return compensation scheme corresponding to the trajectory. This results in the action selection neural network being trained to generate action scores that weight future rewards differently when conditioned on different discount factors.

In some implementations, during the training, the system 100 can generate trajectories for use by the training system 200 in training the action selection neural network(s) 102 using multiple actor computing units. In some of these implementations, each actor computing unit maintains and separately updates a policy (“return computation scheme selection policy”) for selecting between multiple different return computation schemes. This can be beneficial when different actor computing units use different values of ε in ε-greedy control or otherwise differently control the agent. In some other implementations, the system can maintain a central policy that is the same for all of the actor computing units.

When multiple actor computing units are used, each actor computing unit can repeatedly perform the operations described above with reference to FIG. 1 to control an instance of an agent to perform a task episode and use the results of the interactions of the agent during the task episodes to update the return computation scheme selection policy, i.e., either the central policy or the policy separately maintained by the actor computing unit, and to generate training data for training the action selection neural network(s).

A computing unit can be, e.g., a computer, a core within a computer having multiple cores, or other hardware or software, e.g., a dedicated thread, within a computer capable of independently perform operations. The computing units may include processor cores, processors, microprocessors, special-purpose logic circuitry, e.g., an FPGA (field-programmable gate array) or an ASIC (application-specific integrated circuit), or any other appropriate computing units. In some examples, the computing units are all the same type of computing unit. In other examples, the computing units can be different types of computing units. For example, one computing unit can be a CPU while other computing units can be GPUs.

The training system 200 stores trajectories generated by each actor computing unit in a data store referred to as a replay buffer, and at each of multiple training iterations, samples a batch of trajectories from the replay buffer for use in training the action selection neural network(s) 102. The training system 200 can sample trajectories from the replay buffer in accordance with a prioritized experience replay algorithm, e.g., by assigning a respective score to each stored trajectory, and sampling trajectories in accordance with the scores. An example prioritized experience replay algorithm is described in T. Schaul et al., “Prioritized experience replay,” arXiv:1511.05952v4 (2016).

As one example of how training can be distributed between computing units in a distributed setting, the system can make use a set of actors, a learner, a bandit and (optionally) evaluators, as well as a replay buffer.

The actors and evaluators, when used, are the two types of workers that draw samples from the environment.

As described above and below, in some implementations actors collect experience with non-greedy policies, and, in some of these implementations, the system can optionally track the progress of the training by reporting scores from separate evaluator processes that continually execute the greedy policy and whose experience is not added to the replay buffer. Therefore, only the actor workers write to the replay buffer, while the evaluation workers are used purely for reporting the performance.

In the replay buffer, the system can store fixed-length sequences of transitions that do not cross episode boundaries. Optionally, the system can apply DQN pre-processing, e.g., as used in R2D2.

In some implementations, the replay buffer is split into multiple, e.g., 8, shards, to improve robustness due to computational constraints, with each shard maintaining an independent prioritisation of the entries in the shard. The system uses prioritized experience replay, e.g., with a prioritization scheme that uses a weighted mixture of max and mean TD-errors over the sequence.

Each of the actor workers writes to a specific shard which is consistent throughout training.

Given a single batch of trajectories, the system unrolls both online and target networks on the same sequence of states to generate value estimates. These estimates are used to execute the learner update step, which updates the model weights used by the actors, and, optionally, an exponential moving average (EMA) of the weights used by the evaluator models.

Acting in the environment can be accelerated by sending observations from actors and evaluators to a shared server that runs batched inference. The remote inference server allows multiple clients such as actor and evaluator workers to connect to it, and executes their inputs as a batch on the corresponding inference models. The actor and, optionally, evaluator inference model parameters are queried periodically from the learner. Also, the recurrent state is persisted on the inference server so that the actor does need to communicate it. In some implementations, however, the episodic memory lookup required to compute the intrinsic reward is performed locally on actors to reduce the communication overhead.

At the beginning of each episode, parameters β and γ are queried from the bandit worker, i.e., the meta-controller that maintains and updates the return computation scheme selection policy for selecting between return computation schemes.

As a particular example, the parameters can be selected from a set of pairs of coefficients {(βj, γj)} where j ranges from 1 to N, the total number of return computation schemes.

The actors query optimal (β, γ) tuples, while, optionally, the evaluators query the tuple corresponding to the greedy action.

After each actor episode, the bandit stats are updated based on the episode rewards by updating the distribution over actions, e.g., according to Discounted UCB (Garivier and Moulines, 2011) or another multi-arm bandits technique.

As a particular example of a distributed architecture that can be employed by the system, the system can use a TPUv4, e.g., with the 2×2×1 topology used for the learner. Acting is accelerated by sending observations from actors to a shared server that runs batched inference using, e.g., a 1×1×1 TPUv4, which is used for inference within the actor and evaluation workers.

In this architecture, on average, the learner performs 3.8 updates per second. The rate at which environment frames are written to the replay buffer by the actors is approximately 12970 frames per second.

Each experiment consists of 64 actors with 2 threads, each of them acting with their own independent instance of the environment. The collected experience is stored in the replay buffer split in 8 shards, each with independent prioritisation. This accumulated experience is used by a single learner worker, while the performance is optionally evaluated on 5 evaluator workers.

The set of possible intrinsic reward scaling factors

$${\{ {β}_{i} \}}_{i = 0}^{N - 1}$$

(i.e., where N is the number of possible intrinsic reward scaling factors) included in the return computation schemes in the set can include a “baseline” intrinsic reward scaling factor (substantially zero) that renders the overall reward independent of the intrinsic reward.

The other possible intrinsic reward scaling factors can be respective positive numbers (typically all different from each of the others), and can be considered as causing the action selection neural network to implement a respective “exploratory” action selection policy. The exploratory action selection policy, to an extent defined by the corresponding intrinsic reward scaling factor, encourages the agent not only to solve its task but also to explore the environment.

The action selection neural network(s) 102 can use the information provided by the exploratory action selection policies to learn a more effective exploitative action selection policy. The information provided by the exploratory policies may include, e.g., information stored in the shared weights of the action selection neural network(s). By jointly learning a range of action selection policies, the training system 200 may enable the action selection neural network(s) 102 to learn each individual action selection policy more efficiently, e.g., over fewer training iterations. Moreover, learning the exploratory policies enables the system to continually train the action selection neural network even if the extrinsic rewards are sparse, e.g., rarely non-zero.

After the training of the action selection neural network(s) is completed, the system 100 can either continue updating the scheme selection policy and selecting schemes as described above or fix the scheme selection policy and control the agent by greedily selecting the scheme that the scheme selection policy indicates has the highest reward score.

Additionally, in implementations where the system uses the distilled policy neural networks to control the agent during training, the system can either continue using the distilled policy neural networks to control the agent after training or switch to controlling the agent using the action selection neural networks after training.

Generally, the system can use any kind of reward that characterizes exploration progress rather than task progress as the intrinsic reward. One particular example of an intrinsic reward and a description of a system that generates the intrinsic rewards is described below with reference to FIG. 3.

FIG. 2B shows an example architecture of the action selection neural network system 102.

In the example of FIG. 2B, the set of return computation schemes includes N schemes, where N is greater than one.

Generally, each action selection neural network 102 can be implemented with any appropriate neural network architecture that enables it to perform its described function.

In one example, each action selection neural network 102 may include an “embedding” sub-network, referred to in FIG. 2B as a “torso, a “core” sub-network, and one or more “selection” sub-networks (“heads”). A sub-network of a neural network refers to a group of one or more neural network layers in the neural network.

When the observations are images, the embedding sub-network can be a convolutional sub-network, i.e., that includes one or more convolutional neural network layers, that is configured to process the observation for a time step. When the observations are lower-dimensional data, the embedding sub-network can be a fully-connected sub-network.

As a particular example, the convolutional sub-network can be modified version of the NFNet architecture (Brock et al., 2021). The NFNet architecture is a convolutional neural network that does not use any normalization layers.

As one example, the system can use a simplified stem relative to an NFNet that has a single 7×7 convolution with stride 4. The system can also forgo bottleneck residual blocks in favor of 2 layers of 3×3 convolutions, followed by a Squeeze-Excite block. In addition, the system can modify the downsampling blocks by applying an activation prior to the average pooling and multiplying the output by the stride in order to maintain the variance of the activations. This is then followed by a 3×3 convolution. In some implementations, all convolutions can use a Scaled Weight Standardization scheme.

The core sub-network can be a recurrent sub-network, e.g., that includes one or more long short-term memory (LSTM) neural network layers, that is configured to process: (i) the output of the embedding sub-network and, optionally, (ii) data specifying the most recently received extrinsic (and optionally intrinsic) rewards and/or the most recently performed action.

Each selection sub-network can be configured to process the output of the core sub-network to generate the corresponding output, i.e., a corresponding set of action scores or a probability distribution. For example, each selection sub-network can be a multi-layer perceptron (MLP) or other fully-connected neural network.

In some implementations, the system can also provide additional features to the action selection neural network, e.g., to be provided as input to the core neural network. Some examples of these features can include, e.g., the previous action, the previous extrinsic reward, the previous intrinsic reward, the previous RND component of the intrinsic reward, the previous Episodic component of intrinsic reward, the previous action prediction embedding, and so on.

In the example of FIG. 2B, the action selection neural networks share a torso and, optionally, a core sub-network. Thus, each action selection neural network is implemented as multiple heads, i.e., one head to generate the extrinsic action scores and one head to generate the intrinsic action scores, on top of the shared torso and core sub-network.

Moreover, when the distilled policy neural networks are used, each distilled policy neural network is also implemented as a respective head on top of the shared torso and core sub-network.

Thus, when there are N return computation schemes, there are can be one torso and core sub-network but 3N heads, with each scheme having a separate head to generate each of the extrinsic action scores, to generate the intrinsic action scores, and the distilled policy outputs. Alternatively, a single head can generate the N×A probabilities for all of the distilled policy neural networks, where A is the total number of actions.

When target action selection neural networks, target policy neural networks, or both are used, these can also be implemented as separate heads on top of the shared torso and core. Thus, each target action selection neural network can be implemented as two separate heads on top of the shared torso and core and each target policy neural network can be implemented as a separate head on top of the shared torso and core.

FIG. 3 shows an example intrinsic reward system 300. The intrinsic reward system 300 is an example of a system implemented as computer programs on one or more computers in one or more locations in which the systems, components, and techniques described below are implemented.

The intrinsic reward system 300 is configured to process a current observation 212 characterizing a current state of the environment to generate an intrinsic reward 206 that characterizes the progress of the agent in exploring the environment. The intrinsic rewards 206 generated by the system 300 can be used, e.g., by the training system 200 described with reference to FIG. 2A.

The system 300 includes an embedding neural network 302, an external memory 304, and a comparison engine 306, each of which will be described in more detail next.

The embedding neural network 302 is configured to process the current observation 212 to generate an embedding of the current observation, referred to as a “controllability representation” 308 (or an “embedded controllability representation”). The controllability representation 308 of the current observation 212 can be represented as an ordered collection of numerical values, e.g., an array of numerical values. The embedding neural network 302 can be implemented as a neural network having multiple layers, with one or more of the layers performing a function which is defined by weights which are modified during the training of the embedding neural network 302. In some cases, particularly when the current observation is in the form of at least one image, one or more of the layers, e.g. at least the first layer, of the embedding neural network can be implemented as a convolutional layer.

The system 300 may train the embedding neural network 302 to generate controllability representations of observations that characterize aspects of the state of the environment that are controllable by the agent. An aspect of the state of the environment can be referred to as controllable by the agent if it is (at least partially) determined by the actions performed by the agent. For example, the position of an object being gripped by an actuator of a robotic agent can be controllable by the agent, whereas the ambient lighting conditions or the movement of other agents in the environment may not be controllable by the agent. Example techniques for training the embedding neural network 302 are described in more detail below.

The external memory 304 stores controllability representations of previous observations characterizing states of the environment at previous time steps.

The comparison engine 306 is configured to generate the intrinsic reward 206 by comparing the controllability representation 308 of the current observation 212 to controllability representations of previous observations that are stored in the external memory 304. Generally, the comparison engine 306 can generate a higher intrinsic reward 206 if the controllability representation 308 of the current observation 212 is less similar to the controllability representations of previous observations that are stored in the external memory.

For example, the comparison engine 306 can generate the intrinsic reward rₜ as:

$${r}_{t} = {( {\sum }_{{f}_{i} ∈ {N}_{k}} K ( f ( {x}_{t} ) , {f}_{i} ) + c )}^{- 1} \qquad ( 2 )$$

where

$${N}_{k} = {\{ {f}_{i} \}}_{i = 1}^{k}$$

denotes the set of k controllability representations fᵢ in the external memory 304 having the highest similarity (e.g., by a Euclidean similarity measure) to the controllability representation 308 of the current observation 212 (where k is a predefined positive integer value, which is typically greater than one), f(xₜ) denotes the controllability representation 308 of the current observation 212 denoted xₜ, K(·,·) is a “kernel” function, and c is a predefined constant value (e.g., c=0.001) that is used to encourage numerical stability. The kernel function K(·,·) can be given by, e.g.:

$$K ( f ( {x}_{t} ) , {f}_{i} ) = \frac{ϵ}{\frac{{d}^{2} ( f ( {x}_{t} ) , {f}_{i} )}{{d}_{m}^{2}} + ϵ} \qquad ( 3 )$$

where d(f(xₜ), fᵢ) denotes a Euclidean distance between the controllability representations f(xₜ) and fᵢ, ∈ denotes a predefined constant value that is used to encourage numerical stability, and

$${d}_{m}^{2}$$

denotes a running average (i.e., over multiple time steps, such as a fixed plural number of time steps) of the average squared Euclidean distance between: (i) the controllability representation of the observation at the time step, and (ii) the controllability representations of the k most similar controllability representations from the external memory. Other techniques for generating the intrinsic reward 206 that result in a higher intrinsic reward 206 if the controllability representation 308 of the current observation 212 is less similar to the controllability representations of previous observations that are stored in the external memory are possible, and equations (2)-(3) are provided for illustrative purposes only.

Determining the intrinsic rewards 206 based on controllability representations that characterize controllable aspects of the state of the environment may enable more effective training of the action selection neural network. For example, the state of the environment may vary independently of the actions performed by the agent, e.g., in the case of a real-world environment with variations in lighting and the presence of distractor objects. In particular, an observation characterizing the current state of the environment may differ substantially from an observation characterizing a previous state of the environment, even if the agent has performed no actions in the intervening time steps. Therefore, an agent that is trained to maximize intrinsic rewards determined by directly comparing observations characterizing states of the environment may not perform meaningful exploration of the environment, e.g., because the agent may receive positive intrinsic rewards even without performing any actions. In contrast, the system 300 generates intrinsic rewards that incentivize the agent to achieve meaningful exploration of controllable aspects of the environment.

In addition to using the controllability representation 308 of the current observation 212 to generate the intrinsic reward 206 for the current time step, the system 300 may store the controllability representation 308 of the current observation 212 in the external memory 304.

In some implementations, the external memory 304 can be an “episodic” memory, i.e., such that the system 300 “resets” the external memory (e.g., by erasing its contents) each time a memory resetting criterion is satisfied. For example, the system 300 can determine that the memory resetting criterion is satisfied at the current time step if it was last satisfied a predefined number of time steps N>1 before the current time step, or if the agent accomplishes its task at the current time step. In implementations where the external memory 304 is an episodic memory, the intrinsic reward 206 generated by the comparison engine 306 can be referred to as an “episodic” intrinsic reward. Episodic intrinsic rewards may encourage the agent to continually explore the environment by performing actions that cause the state of the environment to repeatedly transition into each possible state.

In addition to determining an episodic intrinsic reward, the system 300 may also determine a “non-episodic” intrinsic reward, i.e., that depends on the state of the environment at every previous time step, rather than just those time steps since the last time the episodic memory was reset. The non-episodic intrinsic reward can be, e.g., a random network distillation (RND) reward as described with reference to: Y. Burda et al.: “Exploration by random network distillation,” arXiv:1810.12894v1 (2018). Non-episodic intrinsic rewards may diminish over time as the agent explores the environment and do not encourage the agent to repeatedly revisit all possible states of the environment.

Optionally, the system 300 can generate the intrinsic reward 206 for the current time step based on both an episodic reward and a non-episodic reward. For example, the system 300 can generate the intrinsic reward Rₜ for the time step as:

$${R}_{t} = {r}_{t}^{episodic} \cdot min \{ max \{ {r}_{t}^{non - episodic} , 1 \} , L \} \qquad ( 4 )$$

where

$${r}_{t}^{episodic}$$

denotes the episodic reward, e.g., generated by the comparison engine 306 using an episodic external memory 304, and

$${r}_{t}^{n o n - episodic}$$

denotes the non-episodic reward, e.g., a random network distillation (RND) reward, where the value of the non-episodic reward is clipped the predefined range [1, L], where L>1.

A few example techniques for training the embedding neural network 302 are described in more detail next.

In one example, the system 300 can jointly train the embedding neural network 302 with an action prediction neural network. The action prediction neural network can be configured to receive an input including respective controllability representations (generated by the embedding neural network) of: (i) a first observation characterizing the state of the environment at a first time step, and (ii) a second observation characterizing the state of the environment at the next time step. The action prediction neural network may process the input to generate a prediction for the action performed by the agent that caused the state of the environment to transition from the first observation to the second observation. The system 300 may train the embedding neural network 302 and the action prediction neural network to optimize an objective function that measures an error between: (i) the predicted action generated by the action prediction neural network, and (ii) a “target” action that was actually performed by the agent. In particular, the system 300 may backpropagate gradients of the objective function through action prediction neural network and into the embedding neural network 302 at each of multiple training iterations. The objective function can be, e.g., a cross-entropy objective function. Training the embedding neural network in this manner encourages the controllability representations to encode information about the environment that is affected by the actions of the agent, i.e., controllable aspects of the environment.

In another example, the system 300 can jointly train the embedding neural network 302 with a state prediction neural network. The state prediction neural network can be configured to process an input including: (i) a controllability representation (generated by the embedding neural network 302) of an observation characterizing the state of the environment at a time step, and (ii) a representation of an action performed by the agent at the time step. The state prediction neural network may process the input to generate an output characterizing the predicted state of the environment at the next step, i.e., after the agent performed the action. The output may include, e.g., a predicted controllability representation characterizing the predicted state of the environment at the next time step. The system 300 can jointly train the embedding neural network 302 and the state prediction neural network to optimize an objective function that measures an error between: (i) the predicted controllability representation generated by the state prediction neural network, and (ii) a “target” controllability representation characterizing the actual state of the environment at the next time step. The “target” controllability representation can be generated by the embedding neural network based on an observation characterizing the actual state of the environment at the next time step. In particular, the system 300 may backpropagate gradients of the objective function through the state prediction neural network and into the embedding neural network 302 at each of multiple training iterations. The objective function can be, e.g., a squared-error objective function. Training the embedding neural network in this manner encourages the controllability representations to encode information about the environment that is affected by the actions of the agent, i.e., controllable aspects of the environment.

FIG. 4 is a flow diagram of an example process 400 for performing a task episode and updating the return computation scheme selection policy. For convenience, the process 400 will be described as being performed by a system of one or more computers located in one or more locations. For example, an action selection system, e.g., the action selection system 100 of FIG. 1, appropriately programmed in accordance with this specification, can perform the process 500.

The system maintains policy data specifying a policy (a “return computation scheme selection policy”) for selecting between multiple different return computation schemes, each return computation scheme assigning a different importance to exploring the environment while performing the episode of the task (step 402).

The system selects, using the return computation scheme selection policy, a return computation scheme from the multiple different return computation schemes (step 404). For example, the return computation scheme selection policy can assign a respective reward score to each scheme that represents a current estimate of a reward signal that will be received if the scheme is used to control the agent for an episode. As one example, to select the return computation scheme, the system can select the scheme that has the highest reward score. As another example, with probability ε the system can select a random scheme from the set of schemes and with probability 1−ε the system can select the scheme that has the highest reward score defined by the policy. As another example, to select the return computation scheme, the system can map the reward scores to a probability distribution over the set of return computation schemes and then sample a scheme from the probability distribution.

The system controls the agent to perform the episode of the task to maximize a return computed according to the selected return computation scheme (step 406). That is, during the task episode, the system conditions the action selection neural network(s) on data identifying the selected return computation scheme.

The system identifies rewards that were generated as a result of the agent performing the episode of the task (step 408). As a particular, example the system can identify the extrinsic rewards, i.e., the rewards that measure the progress on the task, that were received at each of the time steps in the task episode.

The system updates, using the identified rewards, the policy (a “return computation scheme selection policy”) for selecting between multiple different return computation schemes (step 410).

Generally, the system updates the return computation scheme selection policy using a non-stationary multi-armed bandit algorithm having a respective arm corresponding to each of the return computation schemes.

More specifically, the system can generate a reward signal for the bandit algorithm from the identified rewards and then update the return computation scheme selection policy using the reward signal. The reward signal can be a combination of the extrinsic rewards received during the task episode, e.g., an undiscounted extrinsic reward that is an undiscounted sum of the received rewards.

The system can use any of a variety of non-stationary multi-armed bandit algorithms to perform the update.

As a particular example, the system can compute, for each scheme, the empirical mean of the reward signal that has been received for episodes within some fixed number of task episodes of the current episode, i.e., within a most recent horizon of fixed length. The system can then compute the reward score for each scheme from the empirical mean for the scheme. For example, the system can compute the reward score for a given scheme by adding a confidence bound bonus to the empirical mean for the given scheme. The confidence bound bonus can be determined based on how many times the given scheme has been selected within the recent horizon, i.e., so that schemes that have been selected fewer times are assigned larger bonuses. As a particular example, the bonus for a given scheme a computed after the k-th task episode can satisfy:

$$β \sqrt{\frac{1}{{N}_{k - 1} ( a , τ )}} or β \sqrt{\frac{log ( k - min ( k - 1 , τ ) )}{{N}_{k - 1} ( a , τ )}} ,$$

where β is a fixed weight, Nₖ₋₁(α, τ) is the number of times the given scheme a has been selected within the recent horizon, and τ is the length of the horizon.

Thus, the system adaptively modifies the return computation scheme selection policy during the training of the action selection neural network(s), resulting in different return computation schemes being favored by the policy (and therefore being more likely to be selected) at different times during the training. Because the return computation scheme selection policy is based on expected reward signals (that are based on extrinsic rewards) for the different schemes at any given point in the training, the system is more likely to select schemes that are more likely to result in higher extrinsic rewards being collected over the course of the task episode, resulting in higher quality training data being generated for the action selection neural network(s).

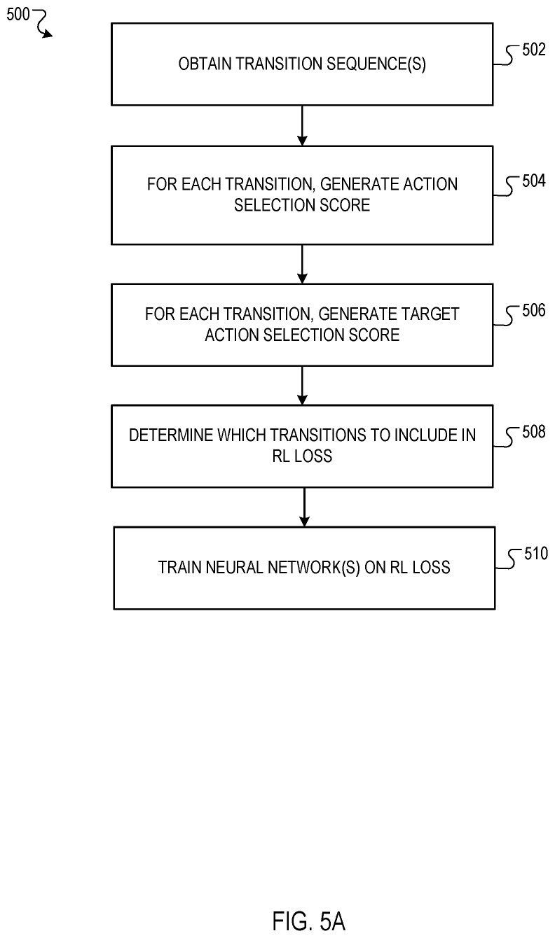

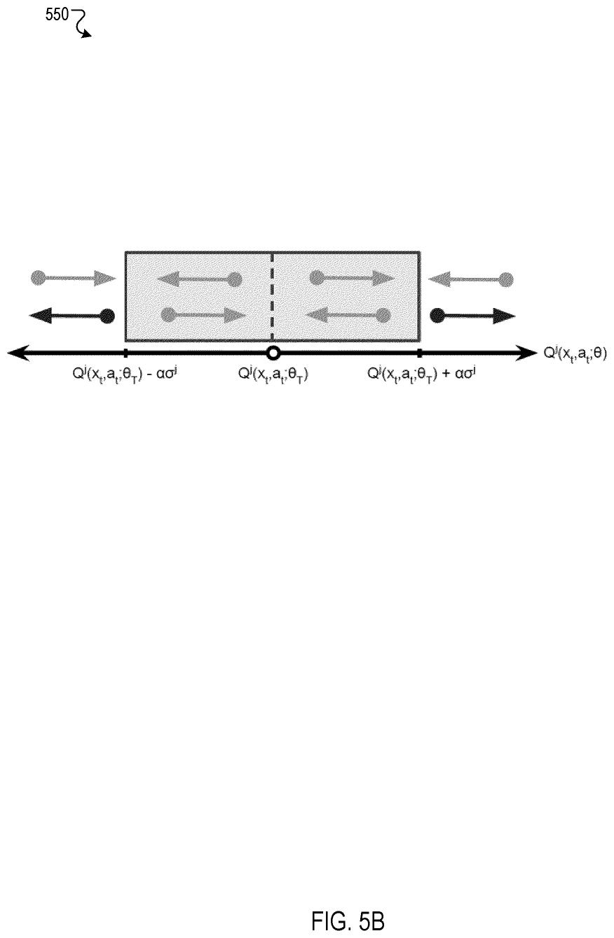

FIG. 5A is a flow diagram of an example process 500 for training the action selection neural network system. For convenience, the process 500 will be described as being performed by a system of one or more computers located in one or more locations. For example, an action selection system, e.g., the action selection system 100 of FIG. 1, appropriately programmed in accordance with this specification, can perform the process 500.

The system obtains a set of one or more transition sequences (“trajectories”), e.g., by sampling the transition sequences from a replay memory (step 502). In some implementations, as described above, the system uses a prioritized replay scheme to sample the transition sequences from the replay memory. For example, the system can use importance sampling when sampling from the replay memory in accordance with the respective priorities of the transition sequences in the replay memory.

Each transition sequence includes a respective transition at each of a plurality of time steps, with each transition including (i) an observation received at the time step, (ii) an action performed in response to the observation, and (iii) one or more rewards received as a result of performing the action. As described above, the actions can have been selected using one of the action selection neural networks or one of the distilled policy neural networks.

The system then computes a reinforcement learning (RL) loss for the set of transition sequences.

In some implementations, for each transition sequence, the system only trains the action selection neural network corresponding to the return computation scheme that was used to generate the transition sequence.

In some other implementations, for each transition sequence, the system can train the all of the action selection neural networks on the transition sequence, i.e., the RL loss is a combined loss that combines respective RL losses for each of the return computation schemes in the set, including those that were not used to generate the transition sequence.

In particular, as part of computing the loss, the system can perform steps 504-508 for each transition in each transition sequence and for each of one or more return computation schemes in the set of one or more return computation schemes.

That is, when the RL loss is only computed for the return computation scheme used to generate any given transition sequence, the system only performs steps 504-508 for that return computation scheme.

When the RL loss is computed for all of the return computation schemes, the system performs steps 504-508 for all of the return computation schemes.

The system processes an action selection input that includes the observation at the time step using the action selection neural network of the action selection neural network system that corresponds to the return computation scheme and in accordance with current values of the network parameters to generate an action score for the action performed in response to the observation (step 504). In particular, the system generates an intrinsic action score for the action and an extrinsic action score using the action selection neural network corresponding to the scheme and then combines them in accordance with the scaling factor for the corresponding scheme.

The system processes the action selection input using a target action selection neural network that corresponds to the return computation scheme to generate a target action score for the action performed in response to the observation (step 506).

As described above, a target neural network corresponding to a given neural network is a neural network that has the same architecture as the given neural network but that has target values of the network parameters that are constrained to change more slowly than the current values of the network parameters of the given neural network during the training.

For example, the target values can be updated to be equal to the current values only after every N training iterations, where an iteration corresponds to training the given neural network on a batch of one or more transition sequences and where Nis greater than 1, and not updating the target values at any other training iterations.

As another example, the target values can be maintained as a moving average of the current values during the training, ensuring that the target values change more slowly. That is, the target values are constrained to change more slowly than the current values of the network parameters during the training, e.g., by virtue of being a moving average of the “online” parameters.

The system then determines whether to include a loss for the transition and for the return computation scheme in the reinforcement learning loss based on the action score for the action performed in response to the observation and the target action score for the action performed in response to the observation (step 508).

The system can determine whether to include a loss for the transition and for the return computation scheme from the action score for the action performed in response to the observation and the target action score for the action performed in response to the observation in any of a variety of ways.

As one example, the system can determine whether the action score for the action is within a trust region radius r of the target action score for the action.

That is, for the j-th scheme and for a transition at time step t, the system determines whether |Q^{j}(xₜ, a_{t′}; θ)−Q^{j}(xₜ, a_{t′}; θ^{T})|>r, where Q^{j}(xₜ, a_{t′}; θ) is the action score for the action at generated by the j-th action selection neural network in accordance with current values of the parameters θ and is the target action score for the action at generated by the j-th target action selection neural network in accordance with target values of the parameters θ^{T}.

The system can then determine to include a loss for the transition in the reinforcement learning loss when the action score for the action is within the trust region radius of the target action score for the action.

The system can compute the trust region radius for a transition in any of a variety of ways.

As one example, the system can determine the trust region radius based on an estimate of a standard deviation of temporal difference (TD) errors computed using action scores computed using the action selection neural network corresponding to the return computation scheme during the training. For example, the trust region radius for the j-the scheme r can be equal to ασⱼ, where α is a fixed hyperparameter and σⱼ is the standard deviation estimate for the j-th action selection neural network.

Generally, a TD error is an error that is computed between an action score generated by an action score neural network for the action performed in response to the observation in a transition at a time step and a corresponding target return estimate that is computed from at least the one or more rewards received at the time step and, optionally, other data, e.g., the next observation at the next transition in the transition sequence.

Thus, the TD error for the j-th scheme and for a transition at time step is equal to Q^{j}(xₜ, a_{t′}; θ)−Gₜ, where Gₜ is the target return estimate.

The target return estimate can be computed using any appropriate Q-learning variant. For example, the target return estimate can be a Retrace target, a Watkins Q(λ) target, or a soft Watkins Q(λ) target as described below.

The system can compute this estimate for the j-th action selection neural network in any of a variety of ways.

As one example, the system can maintain a running estimate

$${σ}_{j}^{running}$$

of the standard deviation of the TD errors for the j-th action selection neural network for sampled transitions throughout training. The system can then set the estimate equal to the running estimate

$${σ}_{j}^{running} .$$

As another example, the system can compute a batch standard deviation

$${σ}_{j}^{batch}$$

of the TD errors for the j-th action selection neural network for the transitions in the one or more transition sequences for the current iteration of the process 500. The system can then set the estimate equal to the batch standard deviation

$${σ}_{j}^{batch} .$$

As yet another example, the system can set the estimate equal to

$$max ( {σ}_{j}^{batch} , {σ}_{j}^{batch} , ϵ ) ,$$

wherein ∈ is a small positive constant to avoid amplification of noise past a specified scale, e.g., a value between 0 and 0.1 or 0 and 0.2.

Setting the trust region radius based on the standard deviation estimate allows the training process to automatically adapt to differing scales of value (in terms of returns) functions throughout the course of training on a single task and across different tasks.

As another example, the system can determine whether the sign of the difference between the action score for the action performed in response to the observation and the target action score for the action performed in response to the observation matches the sign of the TD error for the transition that is computed using at least the action score for the action and the target return estimate computed using at least the one or more rewards for the transition. That is, the system can determine whether sgn(Q^{j}(xₜ, a_{t′}; θ)−Q^{j}(xₜ, a_{t′}; θ^{T}))=sgn(Q^{j}(xₜ, a_{t′}; θ)−Gₜ).

The system can then determine to include a loss for the transition in the reinforcement learning loss when the sign of the difference between the action score for the action performed in response to the observation and the target action score for the action performed in response to the observation matches the sign of a temporal difference (TD) error computed using at least the action score for the action and the target action score computed using at least the one or more rewards for the transition.

As yet another example, the system can use both the sign of the TD error for the transition and the trust region radius to determine whether to include the loss for the transition in the RL loss.

As a particular example, the system can determine to include a loss for the transition in the reinforcement learning loss only when: (i) the action score for the action is within the trust region radius of the target action score for the action, or (ii) the action score for the action is not within the trust region radius of the target action score for the action but the sign of the difference between the action score for the action performed in response to the observation and the target action score for the action performed in response to the observation matches the sign of the TD error for the transition.

This example is illustrated in FIG. 5B.

In particular, FIG. 5B shows an example 550 of which action scores for the j-th return computation scheme for the transition at time step t would be included in the reinforcement learning loss given a particular target action score Q^{j}(xₜ, a_{t′}; θ^{T}) and a particular trust region radius ασⱼ. In FIG. 5B, dots represent action scores and the direction of the corresponding arrows represent the sign of TD error computed using the action score.

As can be seen from FIG. 5B, all action scores within the trust region radius result in the transition being included in the reinforcement loss, while action scores outside the trust region radius result in the transition being included in the reinforcement loss only if the sign matches as described above. That is, from the action scores that are outside the trust region, only the lighter-colored action scores are included in the transition and the darker-colored action scores are not.

Conventional schemes use target neural networks to compute the return estimate. The described approach, on the other hand, uses the target neural network in combination with the trust region radius only to determine whether to include a transition in the reinforcement learning loss or “mask out” the transition to prevent the transition from being used to update the (online) action selection neural network. The use of target neural networks in conventional schemes improves the stability of the training process but places a fundamental restriction on how quickly changes in the Q-function are able to propagate during training. By instead making use of the described scheme, accelerate signal propagation while maintaining stability, improving the data efficiency of the training. In particular, by allowing faster propagation of learning signals related to rare events while maintaining stability, fewer training iterations (and, therefore transitions) are required for the neural network system to achieve acceptable performance.

The system then trains the action selection neural network system using the computed reinforcement learning loss (step 510). As noted, the training procedure may use fewer training iterations. Thus, the present example can save computational resources (memory and computing operations) and/or obtain better performance of the task than a known system for a given budget of computational resources. Furthermore, faster learning results makes possible a reduction in the number of episodes which have to be carried out during the training. This can reduce costs in situations for which transitions are expensive to collect, e.g. many real-world situations in which the agent is a mechanical agent (e.g. a robot) and therefore subject to wear; and/or in a real-world environment in which poor control of the agent during the training has costs for the environment (e.g. a manufacturing environment or a home environment in which an agent may do considerable damage before it is fully trained).

In an example, the system can compute the reinforcement learning loss by, for each transition in each transition sequence for which it was determined to include a loss for the return computation scheme in the reinforcement loss, determining a TD error for the transition and computing the loss for the transition based on the TD error.

For example, the loss can be equal to or proportional to the square of the TD error.

In some implementations, the system maintains a respective estimate σⱼ of the standard deviation of the TD errors for each of the action selection neural networks. In some of these implementations, for each of the action selection neural networks, the system can normalize each of the TD errors for the action selection neural network that will be used in the reinforcement loss using the respective estimate σⱼ of the standard deviation of the TD errors for the action selection neural networks, e.g., by dividing each TD error by the estimate, to generate a normalized TD error and then computes the overall loss for the action selection neural network using the normalized TD errors, e.g., so that the loss is equal to or proportional to the squared normalized TD error.

As the system learns a family of Q-functions which vary over a wide range of discount factors and intrinsic reward scales, the Q-functions within the family can vary considerably in scale. This may cause the larger-scale Q-values to dominate learning and destabilize learning of smaller Q-values. This is a particular concern in environments with very small extrinsic reward scales. Using the normalized TD error when computing the loss can alleviate these issues and ensure that both larger-scale Q values and smaller-scale Q values contribute to the overall loss.

Additionally, as described above, the system can use a prioritized sampling scheme when sampling from the replay memory. In some implementations, this sampling scheme can assign priorities based on TD errors for the transitions in the transition sequences in the replay memory. In some implementations, the system can also normalize the new priorities for the transitions in the one or more transitions, e.g., by determining the new priorities based on the normalized TD errors for the transitions instead of based on the TD errors.

The system can generally compute the target return estimate for a given transition using any appropriate Q-learning variant.

For example, the target return estimate can be a Retrace target.

As another example, the target return estimate can be a variant of a Q(λ) target. Generally, for Q(λ), the return estimate G(t) for a transition at time step t in a transition can be computed as:

$$G ( t ) = {max}_{a} Q ( {x}_{t} , a ) + {\sum }_{k \geq 0} ( {\prod }_{i = 0}^{k - 1} {λ}_{i} ) {γ}^{k} ( {r}_{t + k} + γ {max}_{a} Q ( {x}_{t + k + 1} , a ) - {max}_{a} Q ( {x}_{t + k} , a ) ) ,$$

where λᵢ is computed based on λ, which is a constant between zero and one, inclusive, and controls how much information from the future is used in the return estimation and is generally used as a trace cutting coefficient to perform off-policy correction. Determining λᵢ differently results in different variants of the Q(λ) target.

For example, Peng's Q(λ) target does not perform any kind of off-policy correction and sets λᵢ=λ.

As another example, the Watkins Q(λ) target performs aggressive off-policy correction and sets

$${λ}_{i} = λ {𝕀}_{{a}_{i} ∈ {argmax}_{a} Q ( {x}_{i} , a )}$$

where ∥ is the indicator function. Thus, λᵢ is non-zero only when the action in a transition is the argmax action according to the action selection neural network.

As another example, the system can use an adjusted Watkins Q(λ) return estimate that introduces a tolerance coefficient to make the off-policy correction less aggressive and improve data-efficiency. In particular, the adjusted Watkins Q(λ) return estimate can set

$${λ}_{i} = λ {𝔼}_{a ∼ π ( a \vert {x}_{t} )} [ {𝕀}_{[ Q ( {x}_{t} , {a}_{t} ; θ ) \geq Q ( {x}_{t} , a ; θ ) - κ \vert Q ( {x}_{i} , a ; θ ) \vert ]} ,$$

where κ is the tolerance coefficient and π(a|xₜ) is the output of the distilled policy neural network by processing the observation xₜ. Optionally, the system can use a reduced temperature, e.g., a temperature between zero and one, for the softmax of the distilled policy neural network when performing this sampling Thus, λᵢ is non-zero not only when the action in a transition is the argmax action according to the action selection neural network but also when the action score for the action is within a tolerance region of the action score for the expected action sampled from the distilled policy neural network, where the tolerance region is defined by the tolerance coefficient.

As yet another example, the system can use a soft Watkins Q(λ) return estimate that uses the tolerance coefficient and also replaces each max term in the Q(λ) target above with a corresponding expectation under π for the corresponding observation. That is, each max term is replaced with an expectation of an output generated by the corresponding distilled policy neural network, with or without a reduced temperature.

The adjusted and soft Watkins Q(λ) return estimates result in more transitions being used in computing return estimates and therefore result in increased data efficiency during training.

In other words, the Soft Watkins Q(λ) serves as a trade-off between aggressive trace cutting used within Retrace and Watkins Q(λ), and the lack of off-policy correction in Peng's Q(λ) to allow more transitions to be used in computing return estimates while still accurately correcting for the off-policy nature of the training.

As described above, in some implementations, for each transition sequence, the system can train the all of the action selection neural networks on the transition sequence, i.e., the RL loss is a combined loss that combines respective RL losses for each of the return computation schemes in the set, including those that were not used to generate the transition sequence.

Thus, in these implementations, to compute the combined RL loss for a given transition sequence, for each transition, the system determines, for each of the plurality of return computation schemes, whether to include a loss for the return computation scheme for the transition in the reinforcement learning loss as described above. For each return computation scheme, the system generates an overall loss for the sequence of transitions for the return computation scheme from the respective losses for each of transitions for which it was determined to include the loss for the return computation scheme in the reinforcement loss. For example, the system can average the respective losses for each of transitions for which it was determined to include the loss for the return computation scheme in the reinforcement loss to determine the loss for the scheme.

The system then generates the reinforcement learning loss by combining the respective overall losses for each of the return computation schemes. For example, the system can compute an average or a weighted average of the overall losses for each of the return computation schemes.

In some implementations, the system assigns a greater weight to the overall loss for the return computation scheme that was used to generate the transition sequence than to the overall losses for the other return computation schemes of the plurality of return computation schemes.

For example, the combined loss L can equal to:

$$L = η {L}_{{j}_{u}} + \frac{1 - η}{N} {\sum }_{j = 0}^{N} {L}_{j} ,$$

where N is the total number of return computation schemes, L is the overall loss for return computation scheme j, jᵤ is the index of the return computation scheme used to select the actions for a given transition, and η is the weight assigned to the overall loss for return computation scheme jᵤ and is a fixed hyper parameter between 1/N and 1, exclusive.

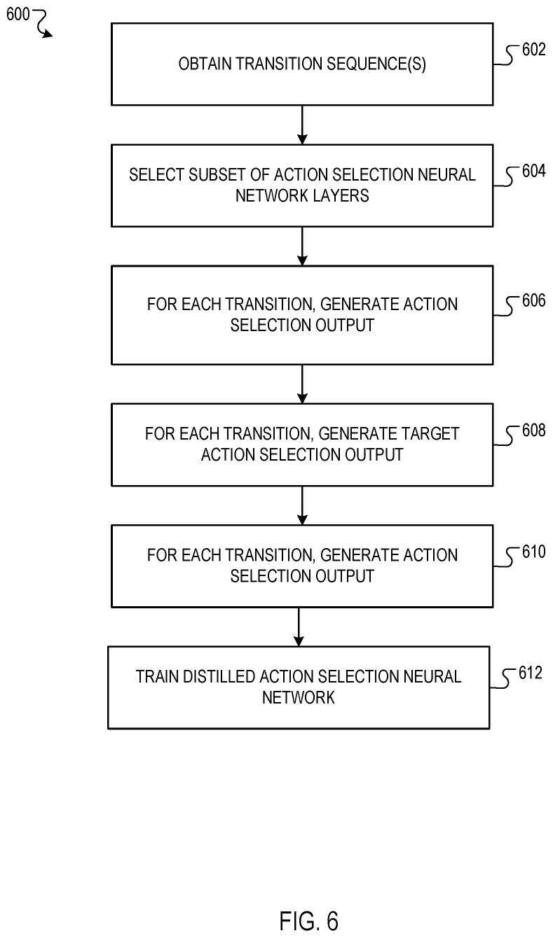

As described above, in some implementations, the system uses the distilled policy neural networks to control the agent at least during training. By training the policy neural networks as described below with reference to FIG. 6 and using the policy neural networks to control the agent, the system can alleviate the deleterious effects of generating training data using the action selection neural networks. In particular, the greedy action of value-based RL algorithms may change frequently over consecutive parameter updates, thus harming off-policy correction methods and the overall training: traces will be cut more aggressively than with a stochastic policy, and bootstrap values will change frequently which can result in a higher variance return estimator. By instead employing the distilled policy neural networks to control the agent, the system instead uses a stochastic action selection policy and avoids much of this negative consequence, making updates more robust under a rapidly-changing policy.

FIG. 6 is a flow diagram of an example process 600 for training a distilled action selection neural network that corresponds to a given return computation scheme. For convenience, the process 600 will be described as being performed by a system of one or more computers located in one or more locations. For example, an action selection system, e.g., the action selection system 100 of FIG. 1, appropriately programmed in accordance with this specification, can perform the process 600.

For example, the distilled action selection neural network can be one of the distilled policy neural networks described above or can be a different neural network that is being trained using (“distilled from”) another action selection neural network that corresponds to the same return computation scheme.

The system obtains a set of one or more transition sequences (step 602), e.g., as described above with reference to step 502 of FIG. 5A.

For each transition sequence, the system selects a subset of layers of a given action selection neural network within the action selection neural network system (step 604).

That is, when there are multiple action selection neural networks within the system, the given action selection neural network is one that corresponds to the same return computation scheme as the distilled policy neural network.

The system can, for example, randomly select a subset of layers from a fixed set of layers that includes some or all of the layers in the given action selection neural network. As a particular example, the fixed set of layers can be the convolutional layers within the embedding sub-network of the action selection neural network described above. That is, as described above, the first action selection neural network and the distilled action selection neural network can have a shared embedding sub-network (shared “neural network torso”) and each subset of layers can be a different, e.g., randomly-selected, subset of layers from the shared neural network torso.

The system then performs steps 606-610 for each of the transition sequences.

For each transition in the transition sequence, the system processes a first action selection input that includes the observation in the transition using the given action selection neural network with the selected subset of layers masked out to generate a respective action selection output for the observation for the selected subset (step 606). “Masking out” a layer refers to setting the layer to the identity transform, so that inputs to the layer are provided unmodified as the outputs of the layer. That is, the system can set an output of the selected subset of layers equal to an input to the selected subset of layers during the processing of the observation. In some implementations, the system can also employ this “temporally consistent depth masking” when generating action selection outputs for transitions when training the action selection neural network system, e.g., as described above with reference to FIG. 5A.

For each transition in the transition sequence, the system applies an action selection policy to the action selection output for the selected subset to generate a target action selection output for the observation that assigns a respective first probability to each action in the set of actions (step 608). As described above, the respective action selection output generated by the action selection neural network includes a respective action score for each action in the set of actions. In these examples, the system can either generate a “greedy” probability distribution that assigns a probability of one to the action with the highest score and a probability of zero to all other agents or apply an exploration policy to the action having the highest respective score to generate the first probabilities. For example, if the exploration policy is an epsilon greedy exploration policy, the system can assign a probability 1−ε to the action with the highest score and (i) a probability of ε to a randomly selected action from the set or (ii) a probability of ε/(N−1) to all other actions in the set, where N is the total number of actions in the set and ε is a constant value between zero and one, exclusive.

For each transition in the transition sequence, the system processes a second action selection input that includes the observation in the transition using the distilled action selection neural network to generate a second action selection output for the observation that defines a respective second probability for each action in the set of actions (step 610). For example, when the distilled action selection neural network is one of the distilled policy neural networks described above, the output of the distilled action selection neural network specifies a probability distribution over the actions in the set of actions.

The system trains the distilled action selection neural network to minimize a policy distillation loss that measures, for each transition in each of the one or more transition sequences, a difference between (i) the first probability assigned to the action in the transition and (ii) the second probability assigned to the action in the transition (step 612).

For example, the policy distillation loss can be a sum of, for each transition, a cross-entropy loss between the (i) the first probability assigned to the action in the transition and (ii) the second probability assigned to the action in the transition.

As another example, the policy distillation loss can be a sum of, for each transition, a cross-entropy loss between the (i) the first probability assigned to the action in the transition and (ii) the second probability assigned to the action in the transition subject to a constraint that sets the cross-entropy loss to zero for transitions that violate the constraint.

For example, the constraint for a given transition can be based on a divergence, e.g., a KL-divergence, between one probability distribution made up of the second probabilities for the set of actions and another probability distribution made up of target probabilities generated by a target distilled action selection neural network by processing the second action selection input for the transition. The constraint can be violated, e.g., whenever the divergence exceeds a threshold value that is pre-determined or that is determined by a hyperparameter sweep.

That is, to evaluate the constraint, the system can process the second action selection input that includes the observation in the transition using the target distilled action selection neural network to generate a target second action selection output for the observation that defines a respective target second probability for each action in the set of actions and determine the divergence between the target second action output and the action selection output. The system can then mask out, i.e., set to zero, the policy distillation loss for the transition when the divergence exceeds the threshold.

After training the distilled action selection neural network, the system can use the distilled action selection neural network to control the agent, e.g., as part of further training of the action selection neural network system or after the training has been completed.

In particular, the system can receive a new observation, process the new observation using the distilled action selection neural network to generate a new action selection output for the new observation that defines a new probability for each action in the set of actions, and then control the agent in response to the new observation using the new action selection output. For example, the system can cause the agent to perform the action that has the highest new probability or cause the agent to perform the action that has the highest new probability with probability 1−ε and causing the agent to perform a random action from the set with probability ε or cause the agent to perform an action selected from the new action selection output using a different action selection policy.

As described above, at test time, i.e., after training the system can use either the action selection neural network or the distilled action selection neural network to control the agent.

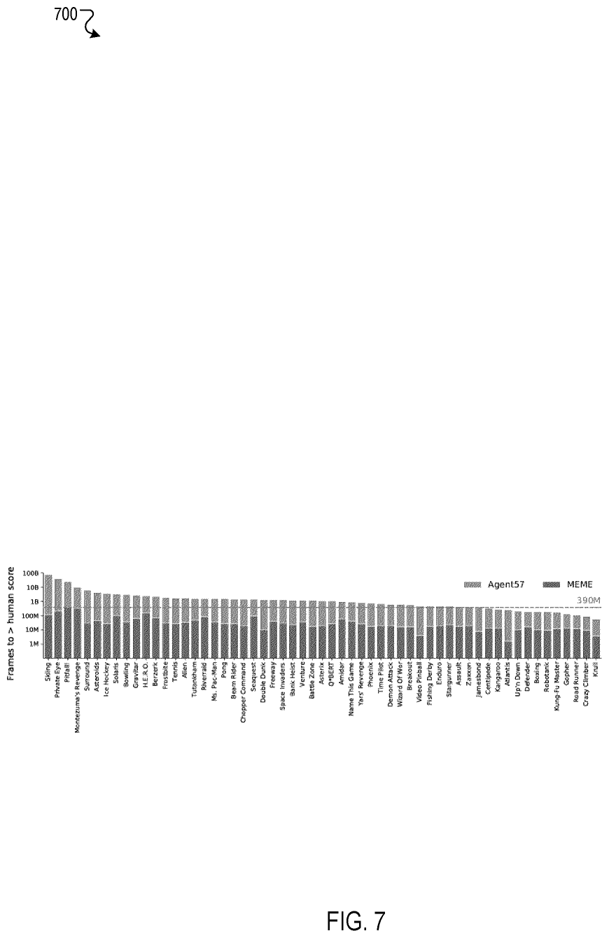

FIG. 7 shows an example 700 of the performance of the described techniques (“MEME”) relative to a conventional approach (“Agent57”) across a variety of tasks. In particular, Agent57 also selects adaptively between multiple return computation schemes but does not include any of the training modifications described in this specification and does not use distilled policy neural networks.

FIG. 7 shows the number of frames, i.e., transitions, that need to be trained on in order for each technique to achieve greater than human performance on a variety of tasks.

As can be seen from FIG. 7, the described techniques consistently require far fewer transitions to exceed human performance than Agent57.

In particular, the scale in FIG. 7 is logarithmic. On average over the set of tasks, MEME achieves above human scores using 63× fewer transitions than Agent 57. Even in the task for which MEME gave the lowest improvement over Agent57, it still required 9× fewer transitions than Agent 57.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

Aspects of the present disclosure may be as set out in the following clauses:
Clause 1. A method for training an action selection neural network system having a plurality of network parameters and for controlling an agent interacting with an environment, the method comprising:
   obtaining a set of one or more transition sequences, each transition sequence comprising a respective transition at each of a plurality of time steps, wherein each transition includes:
      (i) an observation received at the time step,
      (ii) an action performed in response to the observation, and
      (iii) one or more rewards received as a result of performing the action;
   computing a reinforcement learning loss for the set of transition sequences, comprising, for each transition in each transition sequence and for each of one or more return computation schemes in a set of one or more return computation schemes:
      processing an action selection input comprising the observation at the time step using an action selection neural network of the action selection neural network system that corresponds to the return computation scheme and in accordance with current values of the network parameters to generate an action score for the action performed in response to the observation;
      processing the action selection input using a target action selection neural network that corresponds to the return computation scheme to generate a target action score for the action performed in response to the observation, wherein the target action selection neural network has target values of the network parameters that are constrained to change more slowly than the current values of the network parameters during the training; and
      determining whether to include a loss for the transition and for the return computation scheme in the reinforcement learning loss based on the action score for the action performed in response to the observation and the target action score for the action performed in response to the observation; and
   training the action selection neural network system using the computed reinforcement loss.
Clause 2. The method of clause 1, wherein determining whether to include a loss for the transition in the reinforcement learning loss based on the action score for the action performed in response to the observation and the target action score for the action performed in response to the observation comprises:
   determining whether the action score for the action is within a trust region radius of the target action score for the action; and
   determining to include a loss for the transition in the reinforcement learning loss when the action score for the action is within the trust region radius of the target action score for the action.
Clause 3. The method of clause 2, further comprising:
   determining the trust region radius based on an estimate of a standard deviation of temporal difference (TD) errors computed using action scores computed using the action selection neural network corresponding to the return computation scheme during the training.
Clause 4. The method of any one of clauses 1-3, wherein determining whether to include a loss for the transition in the reinforcement learning loss based on the action score for the action performed in response to the observation and the target action score for the action performed in response to the observation comprises:
   determining whether a sign of a difference between the action score for the action performed in response to the observation and the target action score for the action performed in response to the observation matches a sign of a temporal difference (TD) error computed using at least the action score for the action and a target action score computed using at least the one or more rewards for the transition; and
   determining to include a loss for the transition in the reinforcement learning loss when the sign of the difference between the action score for the action performed in response to the observation and the target action score for the action performed in response to the observation matches the sign of a temporal difference (TD) error computed using at least the action score for the action and the target action score computed using at least the one or more rewards for the transition.
Clause 5. The method of clause 4 when dependent on clause 2, wherein determining whether to include a loss for the transition in the reinforcement learning loss based on the action score for the action performed in response to the observation and the target action score for the action performed in response to the observation comprises:
   determining to include a loss for the transition in the reinforcement learning loss only when:
      (i) the action score for the action is within the trust region radius of the target action score for the action, or
      (ii) the action score for the action is not within the trust region radius of the target action score for the action but the sign of the difference between the action score for the action performed in response to the observation and the target action score for the action performed in response to the observation matches the sign of the temporal difference (TD) error computed using at least the action score for the action and the target action score computed using at least the one or more rewards for the transition.
Clause 6. The method of any preceding clause, further comprising:
   maintaining an estimate of a standard deviation of temporal difference (TD) errors computed for the action selection neural network corresponding to the return computation scheme during the training, wherein computing a reinforcement learning loss for the set of transition sequences comprises, for each transition in each transition sequence for which it was determined to include a loss for the return computation scheme in the reinforcement loss:
   determining a TD error for the transition that measures an error between the action score for the action performed in response to the observation in the transition and a target return estimate computed using at least the reward;
   normalizing the TD error based on the estimate of the standard deviation of TD errors to generate a normalized TD error; and
   computing the loss for the transition based on the normalized TD error.
Clause 7. The method of clause 6, wherein obtaining a set of one or more transition sequences comprises sampling the one or more transition sequences from a replay memory based on respective priorities assigned to each of a plurality of transition sequences in the replay memory, and wherein the method further comprises:
   determining a new priority for each of the one or more transition sequences based on the normalized TD errors computed for one or more of the transitions in the transition sequence.
Clause 8. The method of any preceding clause, wherein the set of return computation schemes comprises a plurality of return computation schemes and wherein the action selection neural network system includes a respective action selection neural network corresponding to each of the plurality of return computation schemes, and wherein computing the reinforcement loss comprises:
   for each transition, determining, for each of the plurality of return computation schemes, whether to include a loss for the return computation scheme for the transition in the reinforcement learning loss;
   for each return computation scheme, generating an overall loss for the sequence of transitions for the return computation scheme from the respective losses for each of transitions for which it was determined to include the loss for the return computation scheme in the reinforcement loss; and
   generating the reinforcement learning loss by combining the respective overall losses for each of the return computation schemes.
Clause 9. The method of clause 8, wherein each transition sequence is generated by controlling the agent using outputs generated for a respective one of the return computation schemes and wherein generating the reinforcement learning loss comprises:
   assigning a greater weight to the overall loss for the return computation scheme that was used to generate the transition sequence than to the overall losses for the other return computation schemes of the plurality of return computation schemes.
Clause 10. The method of clause 8 or clause 9, wherein the one or more rewards include an extrinsic reward and an intrinsic reward and wherein each of the plurality of return computation schemes defines a respective weight assigned to the intrinsic reward when computing a return.
Clause 11. The method of clause 10, wherein each of the plurality of return computation schemes also defines a respective value for a discount factor used to compute the return.
Clause 12. The method of any one of clauses 8-10, wherein the respective action selection neural network corresponding to each of the plurality of return computation schemes comprises:
   a torso neural network that is shared among all of the action selection neural networks for the plurality of return computation schemes; and
   an action score head that is specific to the return computation scheme.
Clause 13. The method of any preceding clause, wherein the respective loss for each of the transitions is a Watkins Q(λ) loss.
Clause 14. The method of clause 13, wherein the Watkins Q(λ) loss uses a tolerance coefficient when computing the λ for the transition.
Clause 15. A method for controlling an agent interacting with an environment, the method comprising:
   obtaining a set of one or more transition sequences, each transition sequence comprising a respective transition at each of a plurality of time steps, wherein each transition includes:
      (i) an observation received at the time step,
      (ii) an action performed in response to the observation,
   for each transition sequence:
      selecting a subset of layers of a first action selection neural network within an action selection neural network system;
      for each transition in the transition sequence,
         processing a first action selection input comprising the observation in the transition using the first action selection neural network with the selected subset of layers masked out to generate a respective action selection output for the observation for the selected subset;
         applying an action selection policy to the action selection output for the selected subset to generate a target action selection output for the observation that assigns a respective first probability to each action in the set of actions;
         processing a second action selection input comprising the observation in the transition using a distilled action selection neural network within the action selection neural network system to generate a second action selection output for the observation that defines a respective second probability for each action in the set of actions; and
   training the distilled action selection neural network to minimize a policy distillation loss that measures, for each transition, a difference between (i) the first probability assigned to the action in the transition and (ii) the second probability assigned to the action in the transition;
   after training the distilled action selection neural network:
      receiving a new observation;
      processing the new observation using the distilled action selection neural network to generate a new action selection output for the new observation that defines a new probability for each action in the set of actions; and
      controlling the agent in response to the new observation using the new action selection output.
Clause 16. The method of clause 15, wherein controlling the agent in response to the new observation comprises:
   causing the agent to perform the action that has the highest new probability.
Clause 17. The method of clause 15, wherein controlling the agent in response to the new observation comprises:
   causing the agent to perform the action that has the highest new probability with probability 1−ε and causing the agent to perform a random action from the set with probability ε.
Clause 18. The method of any one of clauses 15-17, wherein the respective action selection output comprises a respective action score for each action in the set, and wherein applying an action selection policy to the action selection output for the selected subset to generate a target action selection output for the observation that assigns a respective first probability to each action in the set of actions comprises:
   determining an action having a highest respective score; and
   applying an exploration policy to the action having the highest respective score.
Clause 19. The method of clause 18, wherein applying an exploration policy to the action having the highest respective score comprises:
   applying an epsilon greedy exploration policy to the action having the highest respective score to assign the respective first probabilities to each of the actions.
Clause 20. The method of any one of clauses 15-19, wherein the first action selection neural network and the distilled action selection neural network have a shared neural network torso, and wherein each subset of layers is a different subset of layers from the shared neural network torso.
Clause 21. The method of any one of clauses 15-20, wherein the first action selection neural network is a respective one of the action selection neural networks corresponding to one of the one or more return computation schemes of any one of clauses 1-14.
Clause 22. The method of any one of clauses 15-21, wherein processing a first action selection input comprising the observation using the first action selection neural network with the selected subset of layers masked out to generate a respective action selection output for the observation for the selected subset comprising setting an output of the selected subset of layers equal to an input to the selected subset of layers during the processing of the observation.
Clause 23. The method of any one of clauses 15-22, wherein training the distilled action selection neural network to minimize a policy distillation loss that measures, for each transition, a difference between (i) the first probability assigned to the action in the transition and (ii) the second probability assigned to the action in the transition comprises:
   for each transition:
      processing the second action selection input comprising the observation in the transition using a target distilled action selection neural network to generate a target second action selection output for the observation that defines a respective target second probability for each action in the set of actions;
      determining a divergence between the target second action output and the action selection output; and
      masking out the policy distillation loss for the transition when the divergence exceeds a threshold.
Clause 24. The method of any preceding clause, wherein the agent is a mechanical agent and the environment is a real-world environment.
Clause 25. The method of clause 24, wherein the agent is a robot.
Clause 26. The method of any preceding clause, wherein the environment is a real-world environment of a service facility comprising a plurality of items of electronic equipment and the agent is an electronic agent configured to control operation of the service facility.
Clause 27. The method of any preceding clause, wherein the environment is a real-world manufacturing environment for manufacturing a product and the agent comprises an electronic agent configured to control a manufacturing unit or a machine that operates to manufacture the product.
Clause 28. The method of any preceding clause, wherein the environment is a simulation of a real-world environment and wherein the method further comprises:
   after the training, controlling a real-world agent in the real-world environment using the action selection neural network system.
Clause 29. The method of any preceding clause, wherein the environment is a simulation of a real-world environment and wherein the method further comprises:
   after the training, providing one or more of the neural network in the action selection neural network system for use in controlling a real-world agent in the real-world environment.
Clause 30. A system comprising:
   one or more computers; and
   one or more storage devices communicatively coupled to the one or more computers, wherein the one or more storage devices store instructions that, when executed by the one or more computers, cause the one or more computers to perform the operations of the respective method of any one of clauses 1-29.
Clause 31. One or more non-transitory computer storage media storing instructions that when executed by one or more computers cause the one or more computers to perform the operations of the respective method of any one of clauses 1-29.

1. A method for training an action selection neural network system having a plurality of network parameters and for controlling an agent interacting with an environment, the method comprising:
obtaining a set of one or more transition sequences, each transition sequence comprising a respective transition at each of a plurality of time steps, wherein each transition includes:
(i) an observation received at the time step,
(ii) an action performed in response to the observation, and
(iii) one or more rewards received as a result of performing the action;
computing a reinforcement learning loss for the set of transition sequences, comprising, for each transition in each transition sequence and for each of one or more return computation schemes in a set of one or more return computation schemes:
processing an action selection input comprising the observation at the time step using an action selection neural network of the action selection neural network system that corresponds to the return computation scheme and in accordance with current values of the network parameters to generate an action score for the action performed in response to the observation;
processing the action selection input using a target action selection neural network that corresponds to the return computation scheme to generate a target action score for the action performed in response to the observation, wherein the target action selection neural network has target values of the network parameters that are constrained to change more slowly than the current values of the network parameters during the training; and
determining whether to include a loss for the transition and for the return computation scheme in the reinforcement learning loss based on the action score for the action performed in response to the observation and the target action score for the action performed in response to the observation; and
training the action selection neural network system using the computed reinforcement loss.

2. The method of claim 1, wherein determining whether to include a loss for the transition in the reinforcement learning loss based on the action score for the action performed in response to the observation and the target action score for the action performed in response to the observation comprises:
determining whether the action score for the action is within a trust region radius of the target action score for the action; and
determining to include a loss for the transition in the reinforcement learning loss when the action score for the action is within the trust region radius of the target action score for the action.

3. The method of claim 2, further comprising:
determining the trust region radius based on an estimate of a standard deviation of temporal difference (TD) errors computed using action scores computed using the action selection neural network corresponding to the return computation scheme during the training.

4. The method of claim 1, wherein determining whether to include a loss for the transition in the reinforcement learning loss based on the action score for the action performed in response to the observation and the target action score for the action performed in response to the observation comprises:
determining whether a sign of a difference between the action score for the action performed in response to the observation and the target action score for the action performed in response to the observation matches a sign of a temporal difference (TD) error computed using at least the action score for the action and a target action score computed using at least the one or more rewards for the transition; and
determining to include a loss for the transition in the reinforcement learning loss when the sign of the difference between the action score for the action performed in response to the observation and the target action score for the action performed in response to the observation matches the sign of a temporal difference (TD) error computed using at least the action score for the action and the target action score computed using at least the one or more rewards for the transition.

5. The method of claim 4 when dependent on claim 2, wherein determining whether to include a loss for the transition in the reinforcement learning loss based on the action score for the action performed in response to the observation and the target action score for the action performed in response to the observation comprises:
determining whether the action score for the action is within a trust region radius of the target action score for the action;
determining to include a loss for the transition in the reinforcement learning loss when the action score for the action is within the trust region radius of the target action score for the action; and
determining to include a loss for the transition in the reinforcement learning loss only when:
(i) the action score for the action is within the trust region radius of the target action score for the action, or
(ii) the action score for the action is not within the trust region radius of the target action score for the action but the sign of the difference between the action score for the action performed in response to the observation and the target action score for the action performed in response to the observation matches the sign of the temporal difference (TD) error computed using at least the action score for the action and the target action score computed using at least the one or more rewards for the transition.

6. The method of claim 1, further comprising:
maintaining an estimate of a standard deviation of temporal difference (TD) errors computed for the action selection neural network corresponding to the return computation scheme during the training, wherein computing a reinforcement learning loss for the set of transition sequences comprises, for each transition in each transition sequence for which it was determined to include a loss for the return computation scheme in the reinforcement loss:
determining a TD error for the transition that measures an error between the action score for the action performed in response to the observation in the transition and a target return estimate computed using at least the reward;
normalizing the TD error based on the estimate of the standard deviation of TD errors to generate a normalized TD error; and
computing the loss for the transition based on the normalized TD error.

7. The method of claim 6, wherein obtaining a set of one or more transition sequences comprises sampling the one or more transition sequences from a replay memory based on respective priorities assigned to each of a plurality of transition sequences in the replay memory, and wherein the method further comprises:
determining a new priority for each of the one or more transition sequences based on the normalized TD errors computed for one or more of the transitions in the transition sequence.

8. The method of claim 1, wherein the set of return computation schemes comprises a plurality of return computation schemes and wherein the action selection neural network system includes a respective action selection neural network corresponding to each of the plurality of return computation schemes, and wherein computing the reinforcement loss comprises:
for each transition, determining, for each of the plurality of return computation schemes, whether to include a loss for the return computation scheme for the transition in the reinforcement learning loss;
for each return computation scheme, generating an overall loss for the sequence of transitions for the return computation scheme from the respective losses for each of transitions for which it was determined to include the loss for the return computation scheme in the reinforcement loss; and
generating the reinforcement learning loss by combining the respective overall losses for each of the return computation schemes.

9. The method of claim 8, wherein each transition sequence is generated by controlling the agent using outputs generated for a respective one of the return computation schemes and wherein generating the reinforcement learning loss comprises:
assigning a greater weight to the overall loss for the return computation scheme that was used to generate the transition sequence than to the overall losses for the other return computation schemes of the plurality of return computation schemes.

10. The method of claim 8, wherein the one or more rewards include an extrinsic reward and an intrinsic reward and wherein each of the plurality of return computation schemes defines a respective weight assigned to the intrinsic reward when computing a return.

11. The method of claim 10, wherein each of the plurality of return computation schemes also defines a respective value for a discount factor used to compute the return.

12. The method of claim 8, wherein the respective action selection neural network corresponding to each of the plurality of return computation schemes comprises:
a torso neural network that is shared among all of the action selection neural networks for the plurality of return computation schemes; and
an action score head that is specific to the return computation scheme.

13. The method of claim 1, wherein the respective loss for each of the transitions is a Watkins Q(λ) loss.

14. The method of claim 13, wherein the Watkins Q(λ) loss uses a tolerance coefficient when computing the λ for the transition.

15. A method for controlling an agent interacting with an environment, the method comprising:
obtaining a set of one or more transition sequences, each transition sequence comprising a respective transition at each of a plurality of time steps, wherein each transition includes:
(i) an observation received at the time step,
(ii) an action performed in response to the observation,
for each transition sequence:
selecting a subset of layers of a first action selection neural network within an action selection neural network system;
for each transition in the transition sequence,
processing a first action selection input comprising the observation in the transition using the first action selection neural network with the selected subset of layers masked out to generate a respective action selection output for the observation for the selected subset;
applying an action selection policy to the action selection output for the selected subset to generate a target action selection output for the observation that assigns a respective first probability to each action in the set of actions;
processing a second action selection input comprising the observation in the transition using a distilled action selection neural network within the action selection neural network system to generate a second action selection output for the observation that defines a respective second probability for each action in the set of actions; and
training the distilled action selection neural network to minimize a policy distillation loss that measures, for each transition, a difference between (i) the first probability assigned to the action in the transition and (ii) the second probability assigned to the action in the transition;
after training the distilled action selection neural network:
receiving a new observation;
processing the new observation using the distilled action selection neural network to generate a new action selection output for the new observation that defines a new probability for each action in the set of actions; and
controlling the agent in response to the new observation using the new action selection output.

16. The method of claim 15, wherein controlling the agent in response to the new observation comprises:
causing the agent to perform the action that has the highest new probability.

17. The method of claim 15, wherein controlling the agent in response to the new observation comprises:
causing the agent to perform the action that has the highest new probability with probability 1−ε and causing the agent to perform a random action from the set with probability ε.

18. The method of claim 15, wherein the respective action selection output comprises a respective action score for each action in the set, and wherein applying an action selection policy to the action selection output for the selected subset to generate a target action selection output for the observation that assigns a respective first probability to each action in the set of actions comprises:
determining an action having a highest respective score; and
applying an exploration policy to the action having the highest respective score.

19. The method of claim 18, wherein applying an exploration policy to the action having the highest respective score comprises:
applying an epsilon greedy exploration policy to the action having the highest respective score to assign the respective first probabilities to each of the actions.

20. The method of claim 15, wherein the first action selection neural network and the distilled action selection neural network have a shared neural network torso, and wherein each subset of layers is a different subset of layers from the shared neural network torso.

21. (canceled)

22. The method of claim 15, wherein processing a first action selection input comprising the observation using the first action selection neural network with the selected subset of layers masked out to generate a respective action selection output for the observation for the selected subset comprising setting an output of the selected subset of layers equal to an input to the selected subset of layers during the processing of the observation.

23. The method of claim 15, wherein training the distilled action selection neural network to minimize a policy distillation loss that measures, for each transition, a difference between (i) the first probability assigned to the action in the transition and (ii) the second probability assigned to the action in the transition comprises:
for each transition:
processing the second action selection input comprising the observation in the transition using a target distilled action selection neural network to generate a target second action selection output for the observation that defines a respective target second probability for each action in the set of actions;
determining a divergence between the target second action output and the action selection output; and
masking out the policy distillation loss for the transition when the divergence exceeds a threshold.

24-29. (canceled)

30. A system comprising:
one or more computers; and
one or more storage devices communicatively coupled to the one or more computers, wherein the one or more storage devices store instructions that, when executed by the one or more computers, cause the one or more computers to perform operations for training an action selection neural network system having a plurality of network parameters and for controlling an agent interacting with an environment, the operations comprising:
obtaining a set of one or more transition sequences, each transition sequence comprising a respective transition at each of a plurality of time steps, wherein each transition includes:
(i) an observation received at the time step,
(ii) an action performed in response to the observation, and
(iii) one or more rewards received as a result of performing the action;
computing a reinforcement learning loss for the set of transition sequences, comprising, for each transition in each transition sequence and for each of one or more return computation schemes in a set of one or more return computation schemes:
processing an action selection input comprising the observation at the time step using an action selection neural network of the action selection neural network system that corresponds to the return computation scheme and in accordance with current values of the network parameters to generate an action score for the action performed in response to the observation;
processing the action selection input using a target action selection neural network that corresponds to the return computation scheme to generate a target action score for the action performed in response to the observation, wherein the target action selection neural network has target values of the network parameters that are constrained to change more slowly than the current values of the network parameters during the training; and
determining whether to include a loss for the transition and for the return computation scheme in the reinforcement learning loss based on the action score for the action performed in response to the observation and the target action score for the action performed in response to the observation; and
training the action selection neural network system using the computed reinforcement loss.

31. (canceled)
